(19) United States
(12) Patent Application Publication
(10) Pub. No.: US 2007/0106513 A1
(43) Pub. Date: May 10, 2007

(54) Method for facilitating text to speech synthesis using a differential vocoder

(76) Inventors: Marc A. Boillot, Plantation, FL (US); Md S. Islam, Cooper City, FL (US); Daniel J. Landron, Margate, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/270,903

(22) Filed: Nov. 10, 2005

(51) Int. Cl. G10L 13/08

(52) U.S. Cl. 704/260

(57) ABSTRACT

A text to speech system (100) uses differential voice coding (230, 416) to compress a database of digitized speech waveform segments (210). A seed waveform (535) is used to precondition each speech waveform prior to encoding which, upon encoding, provides a seeded preconditioned encoded speech token (550). The seed portion (541) may be removed and the preconditioned encoded speech token portion (542) may be stored in a database for text to speech synthesis. When speech it to be synthesized, upon requesting the appropriate speech waveform for the present sound to be produced, the seed portion is preappended to the preconditioned encoded speech token for differential decoding.

### TECHNICAL FIELD

The invention relates in general to the field of text to speech synthesis, and more particularly, to improving the segmentation quality of speech tokens when used in conjunction with a vocoder for data compression.

### BACKGROUND OF THE INVENTION

Text-to-speech synthesis technology provides machines the ability to convert written language in the form of text into audible speech, with the goal of providing text-based information to people in a voiced, audible form. In general, a text to speech system can produce an acoustic waveform from text that is recognizable as speech. More specifically, speech generation involves mapping a string of phonetic and prosodic symbols into a synthetic speech signal. It is desirable for a text to speech system to provide synthesized speech that is intelligible and sounds natural. Typically, during a text-to-speech conversion process, text is mapped to a series of acoustic symbols. These acoustic symbols are further mapped to digitized speech segment waveforms.

A text to speech engine is generally the composition of two stages; a text parser and a speech synthesizer. The text parser disassembles the text into smaller textual based phonetic and prosodic symbols. The text parser includes a dictionary which attempts to identify the phonetic symbols which will best define the acoustic representation of the text for each letter, group of letters, or word. Each of the phonetic symbols is mapped to a digital representation of a sound unit that is stored in a database. The text parser dictionary is responsible for identifying and determining which sound unit in the available database best corresponds to the text. The parsing process invokes a mapping process that first identifies text tokens and then categorizes each text token (letter, group of letters, or word) as corresponding to a specific sound unit. The speech synthesizer is then responsible for actuating the mapping process and producing the acoustic speech from the phonetic symbols. The speech synthesizer receives as input a sequence of phonetic symbols, retrieving a sound unit for each symbol, and then performs the task of concatenating the sound units together to form a speech signal.

The concatenation approach is flexible because it simply strings sound units together to create a digital waveform. The resulting waveform includes the identified sound units that serve as the elemental building blocks to constructing words, phrases, and sentences. The process of parsing the text string is commonly referred to as segmentation, for which a varied number of algorithmic approaches may be employed. Text segmentation algorithms process decision metrics or rules that determine how the text will be broken down into individual text units. The text units are commonly labeled as phonemes, diphones, triphones, dipthongs, affricates, nasals, plosives, glides, or other speech entities. The concatenation of the text units represents a phonetic description of the text string that is interpreted as a language model. The language model is used to reference the text-to-speech database. A text to speech engine uses a database of sound units, each of which individually, or in combination, correspond to a text unit. Databases can store hundreds to thousands of sound units that is accessed for concatenation purposes during speech synthesis. The synthesis portion retrieves sound units, each of which corresponds to a particular text unit.

The concatenation approach allows for blending methods at the transition sections between sound units. The blending of the individual units at the transition borders is commonly referred to as smoothing. Smoothing may be performed in the time domain or the frequency domain. Both approaches can introduce transition discontinuities, but, in general, frequency domain approaches are more computationally expensive than time domain processing methods. Proper phase alignment is necessary in the frequency domain, though not always sufficient to mitigate boundary discontinuities. Smoothing techniques generally involve windowing the sound units to taper the ends, a correlation process to find a best alignment position, and an overlap and add process to blend the transition boundaries. A known disadvantage of the smoothing approach is that discontinuities can still occur when the diphones from different words are combined to form new words. These discontinuities are the result of slight differences in frequency, magnitude, and phase between different diphones or sound units as spoken in different words.

When synthesizing speech, the input text is parsed to determine to which sound unit each text unit corresponds. The corresponding sound unit data is then fetched and concatenated with previous sound units, if any, and the transition is smoothed. To faithfully reproduce speech a database including a substantial number of sound units is needed. If the sound units are stored in uncompressed sampled form, a significant amount of storage space in memory or bulk storage is needed. In memory constrained devices such as, for example, mobile communication devices and personal digital assistants, memory space is at a premium, and it is desirable to reduce the amount of memory space needed to store data. More specifically, it is desirable to compress or otherwise reduce the data so as to occupy as little memory space as is practical.

A similar problem exists in mobile communications. Given the narrow bandwidth available in a typical mobile communications channel, it is desirable to reduce the sampled audio so that little information is lost, but the information can still be transmitted over the channel with the requisite fidelity. In digital mobile communication systems it is common to encode the sampled audio signal by various techniques, generally referred to as vocoding. Vocoding involves modeling the sampled audio signal with a set of parameters and coefficients. The receiving entity essentially reconstructs the audio signal frame by frame using the parameters and coefficients.

Vocoding schemes can generally be categorized as differential and non-differential. In non-differential vocoding, each frame of sampled audio information is encoded without the context of adjacent information. That is, each frame stands on it's own, and is decoded on its own, without reference to other audio information. In a differential vocoding scheme, each frame of audio information affects the encoding of subsequent frames. The use of context in this manner allows for further reduction of the bandwidth of the information. In memory constrained devices and systems, speech information may be stored in vocoded form to reduce the amount of memory needed to store the text to speech sound unit database.

In a device employing a differential vocoder to synthesize speech a problem exists because a differential vocoder relies on information from a previously decoded data frame. But when fetching individual sound units based on text input, the sound units would have to have been encoded in correspondence with the text being converted to speech, otherwise the differential context is not present. Therefore there is a need to provide sound units in a device in a way that they is used by a differential vocoder for converting text to speech.

### SUMMARY OF THE INVENTION

In accordance with an embodiment of the invention, a text-to-speech system employs a database of acoustic speech waveform units that it uses during text to speech synthesis. Another embodiment of the invention provides a means to create the database and a means for preconditioning speech waveform units to be used during text to speech synthesis to alleviate the high memory requirements of a conventional text to speech database. A differential vocoder encodes the acoustic speech waveform units in a conventional text to speech database into a text to speech database of encoded speech tokens. The encoded speech tokens correspond to the acoustic speech waveform units in compressed format as a result of differential encoding. An embodiment of the invention includes a preconditioning process during the encoding to satisfy the requirement of a differential vocoder. One embodiment of the invention provides a system and method of pre-appending a seed waveform unit to an acoustic speech waveform unit prior to differential encoding in order to account for the behavior of the differential vocoder. The purpose of the seed waveform is to effectively prime the vocoder and establish a state within the vocoder that allows it to properly capture the onset dynamics of a fast rising speech waveform. A text to speech database contains a significant number of acoustic speech waveform units that each represents a part of a speech sound. Many speech sounds are fast rising with onset dynamics that need to be effectively captured during the encoding to preserve the perceptual cues associated with the speech sound. The seed waveform has a time length which corresponds to the process delay of the differential vocoder and which allows the vocoder to prepare for the fast rising speech waveform.

During initial database construction, each of the acoustic speech waveform units is pre-appended with a seed waveform unit prior to encoding to provide a preconditioned encoded speech token upon encoding The preconditioned encoded speech tokens minimize the effects of onset corruption during text to speech synthesis with the effect that the preconditioning improves the speech blending properties at the discontinuous frame boundaries thereby improving speech synthesis quality when the text to speech is performed by a differential vocoder. The preconditioning method involves pre-appending a seed waveform unit to the acoustic speech waveform unit prior to encoding, then stripping off the corresponding seed token from the seeded preconditioned encoded speech token before storing the preconditioned encoded speech token as the corresponding acoustic speech waveform token in the compressed database. The database of preconditioned encoded speech tokens is created and this database is used for the text to speech database of acoustic speech waveform units during text to speech. The preconditioned encoded speech tokens are processed by a differential vocoder during text to speech synthesis of the acoustic speech waveform units. During synthesis, the requested preconditioned encoded speech token corresponding to the desired acoustic speech waveform unit is pre-appended with a seed token which, together, are passed to the differential vocoder for decoding. The differential vocoder decodes the seeded preconditioned encoded speech token and generates a synthesized acoustic waveform unit which contains a waveform seed unit. In one embodiment of the invention, the device then strips off the waveform seed unit to provide the acoustic synthesized waveform unit that corresponds to the original text to speech database acoustic speech token. Therefore, the use of a seed token and preconditioned encoded speech tokens reduce the amount of storage required for the database.

### BRIEF DESCRIPTION OF THE DRAWINGS

FIG. 1 shows a block flow chart diagram of a text to speech process, in accordance with an embodiment of the invention;

FIG. 2 shows a block process diagram of a method of synthesizing speech, in accordance with an embodiment of the invention;

FIG. 3 shows a process flow diagram for encoding and decoding speech units;

FIG. 4 shows a process flow diagram for encoding and decoding speech units, in accordance with an embodiment of the invention;

FIG. 5 shows a process flow chart diagram of a method of generated a database of seeded preconditioned encoded speech tokens, in accordance with an embodiment of the invention;

FIG. 6. shows a flow chart diagram of a method for converting text to speech, in accordance with an embodiment of the invention; and

FIG. 7. shows a flow chart diagram of a method of decoding a seeded preconditioned encoded speech token for text to speech operation, in accordance with an embodiment of the invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward.

Limitations in the processing power and storage capacity of handheld portable devices limit the size of the text to speech database that can be stored on the mobile device. Hence, according to an embodiment of the invention, text to speech systems on embedded devices with limited processing capabilities, and limited memory utilize speech compression techniques to reduce the size of the database that is stored on the mobile device. In place of sampled digital speech waveforms representing the phonetic units, the text to speech database of the invention uses vocoded speech parameters for each speech waveform conventionally used in text to speech synthesis. A database which would conventionally contain digital sampled waveforms representing the acoustic symbols instead contains vocoder parameter vectors for each of the digital waveforms. The parameterized vectors reduce the amount of memory required to store each sound unit. Each digital waveform is represented as a vector of parameters wherein the parameters are used by a vocoder to decode the parameterized speech vector.

A vocoder is a speech analyzer and synthesizer developed as a speech coder for telecommunication applications to code speech for transmission, thereby reducing the channel bandwidth requirement. Vocoding techniques are also used for secure radio communication, where voice has to be digitized, encrypted and then transmitted on a narrow, voice-bandwidth channel. A vocoder examines the time-varying and frequency-varying properties of speech and creates a model that best represents the features of the speech frame being encoded. A vocoder typically operates on framed speech segments, where the frame width is short enough that the speech is considered to be stationary during the frame. The vocoding process assumes that speech is a slowly varying signal that is represented by time varying model. The vocoder performs analysis on the speech frames and produces parameters that represent the speech model during that frame. Each frame is then transmitted to a remote station. At the remote station a vocoder uses these frame model parameters to produce the speech for that frame. The function of the vocoder is to reduce the amount of redundant information that is contained in speech given that speech is generally slowly time-varying. The vocoding process substantially reduces the amount of data needed to transmit or store speech. Vocoders such as vector sum excited linear prediction (VSELP), adaptive multi-rate (AMR), code excited linear predictive (CELP), residual excited linear predictive (RELP), and that specified in the well-known Global Standard on Mobile telecommunications (GSM), to name a few examples, operate directly on the short time frame segments without referral to previous speech frame information. These vocoders receive a speech segment and return a set of parameters, which represent that speech segment based on the vocoder model. The model is one of any type such as LPC, cepstral, Line Spectral Pair, formant vocoder, or phase vocoder. These non-differential vocoding models are memoryless in that only the current short time speech frame is necessary to generate the vocoded speech parameters. However, other types of vocoders known as differential based vocoders utilize information from previous frames to generate the current frame speech parameter information. The parameters from the previously encoded speech frames are used encode the current frame. Differential vocoders are memory based vocoders in that it is necessary for them to store information, or history, from past frames during the encoding and decoding. Differential vocoders therefore depend on previous encoding knowledge during vocoder processing.

The use of a vocoder in a text to speech system reduces the amount of data that needs to be stored on a memory constrained device. A standard non-differential vocoder, which does not preserve frame history information, is integratable within a text to speech engine. For a non-differential vocoder, each acoustic sampled waveform token, corresponding to a speech sound, is directly replaced with its encoded vocoder parameter vector. During text to speech operation the non-differential vocoder effectively synthesizes the acoustic sampled waveform token directly from the encoded vocoder parameter vector. The synthesized waveform token effectively replaces the acoustic waveform. For a non-differential vocoder the synthesized waveform tokens are identical to the acoustic waveform tokens.

However, for a differential vocoder, if directly encoded frames were used, there would be significant onset corruption due to the differential nature of the differential vocoding process, and the lack of previous information. In creating the database, simply encoding the acoustic speech waveform units into tokens and then decoding the tokens does not produce useable acoustic speech units. The differential vocoder attempts to synthesize an acoustic speech unit from the token assuming that a previously synthesized token is used in the generation of a current token. In continuous speech, a differential vocoder expects the previous speech waveform unit to be correlated to the current speech waveform unit. A vocoder operates according to certain assumptions about speech to achieve significant compression. The fundamental assumption is that the vocoder is vocoding a speech stream which is slowly time varying, relative to the vocoder clock. In the context of a text to speech system, however, this assumption does not hold because the speech is synthesized from the concatenation of stored speech tokens, rather than from actual speech. Each token is coded independently. Thus, applying a differential vocoder to directly compress the text to speech acoustic waveform units will results in synthesized waveform units that exhibit onset corruption due to mathematical expectations inherent in the differential vocoding. The onset corruptions would be slightly noticeable on the synthesized waveform units but would not be perceptually significant until the synthesized waveforms were actually concatenated together by a blending process. The blending process attempts to smooth out discontinuities between the concatenated speech by applying smoothing functions. Certain blending techniques rely on correlation-based measures to determine the optimal overlap before blending. Blending can reduce the onset disruptions, but onset disruptions will cause the blending techniques to falsely assume information about the blending regions. These onset disruptions are a form of distortion that occurs at the onset of the synthesized speech token. The evaluation of various vocoders in text to speech database compression involve running a vocoder on each of the stored speech waveform tokens and generating a set of encoded parameters for each waveform token. The assessment of a differential vocoder directly applied to a text to speech database would be perceived as degrading the synthesized speech quality. Hence, a method of improving the performance of a differential vocoder within a text to speech system is needed. The invention provides a preconditioning method that adequately prepares the differential vocoder to better operate on small acoustic speech units and improve the quality of the synthesized speech by improving the quality of the onset regions. text to speech synthesis essentially requires three basic steps: 1) the text is parsed, breaking it up into sentences, words, and punctuations, 2) for each word, a dictionary is used to determine the phonemes to pronounce that word, and 3) the phonemes are used to extract recorded voice segments from a database, and they are concatenated together to produce speech.

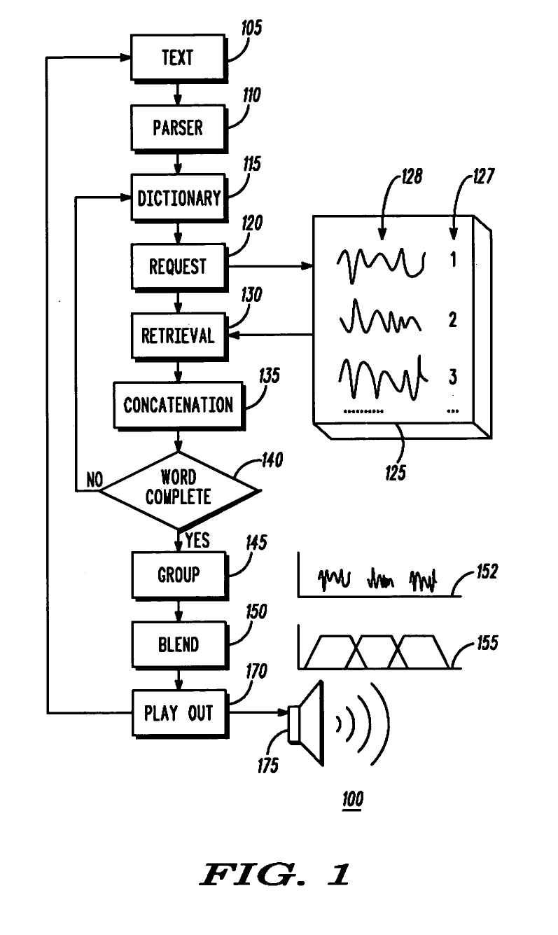

Referring now to FIG. 1, there is shown a block flow chart diagram of a text to speech synthesis process 100, in accordance with an embodiment of the invention. Text 105 is provided to start the process. The text is then parsed by a parsing function 110 which identifies or segments the text characters and character groupings from punctuation. The segmented text characters are identified using a dictionary process 1 15 to determine which diphones are needed to pronounce the text. Diphones are formed from a pair of partial phonemes. A diphone represents the end of one phoneme and the beginning of another and is significant since there is less variation in the middle of a phoneme than there is at the beginning and ending sections. The use of diphones make the artificial speech sound more natural since it captures the natural transition between phonemes. The text parsing process operates directly on the provided text and splits the original text into a marked-up text language that is interpreted by the dictionary to determine the required diphones. The dictionary process identifies the required phonemes and generates a request 120 for a diphone 126 from the text to speech database 125. In response, the text to speech database provides the diphone to the text to speech engine which retrieves 130 the requested diphone 126. The diphone is provided as a digital data structure representing an acoustic speech unit for reproducing a speech part for pronouncing that portion of the text to which it corresponds. After the requested diphone 126 is retrieved from the text to speech database 125 it is concatenated with a concatenation process 135 with previous diphones to construct an acoustic word. An acoustic word is a concatenation of one or more diphones, hence the synthesis process 100 may continue to look up other diphone segments via the dictionary process 115 after the individual word parsing 110. The synthesis process 100 checks to determine when all the diphones have been received for a word being parsed 140 before continuing to the synthesis portion. When all diphones are received and concatenated they are passed forward to a grouping process 145. At the same time, the text parsing process may begin on the next word. The concatenated diphones 152 are blended with a blending process 150 to provide smooth boundary transitions between the diphones. Tapering filters 155 are used for smoothing the diphones, which are applied to suppress artificial sounds (audio artifacts) which would be otherwise generated during the blending process 150. The tapering filter tapers the beginning and end of a diphone in the time domain, meaning the amplitude of the diphone is gradually increased from a low level at the beginning of the diphone, and gradually reduced at the end of the diphone. The blending is preferably an overlap and add operation that combines the diphones together and ensures that the blending between the diphones provide the smoothest transition. Correlation based techniques may be employed in the blending process to determine the optimal point at which the ‘overlap and add’ process can generate the least signal distortion, and align the diphones such that their periodicity occurs at the same point in time so that adding the diphone signals together in these regions can provide a more cohesive signal. In a concatenation of two adjacent speech units during speech synthesis, it is beneficial to minimize acoustical mismatch to create a natural speech from an input text. Upon completion of the blending, the speech is converted to analog form by a play out process 170, which provides the analog speech signal to a speaker or acoustic transducer 175. The text to speech database 125 contains a plurality of acoustic speech waveform units 126, each organized by an index value 127, and each corresponds to a particular diphone. The index value keys each acoustic speech waveform unit to a unique diphone symbol representing the acoustic speech diphone utterance. The dictionary process 115 recognizes which diphones represent the textual word and uses the index value 127 to send a request 120 to the database 125 associated with the diphone. The text to speech database 125 receives and acts on the request, which includes the index value to lookup the corresponding acoustic speech waveform unit. In this regard, the text to speech engine only responds to requests in the form of an index query initiated by a request process 120. Because the text to speech system is not concerned with how the text to speech database retrieves the acoustic speech waveform units it may be replaced by a vocoder system with a compressed database that stores compressed versions of the acoustic speech waveform units. When a request is made, the vocoder returns a synthesized version of the requested acoustic speech waveform unit from the compressed database waveforms.

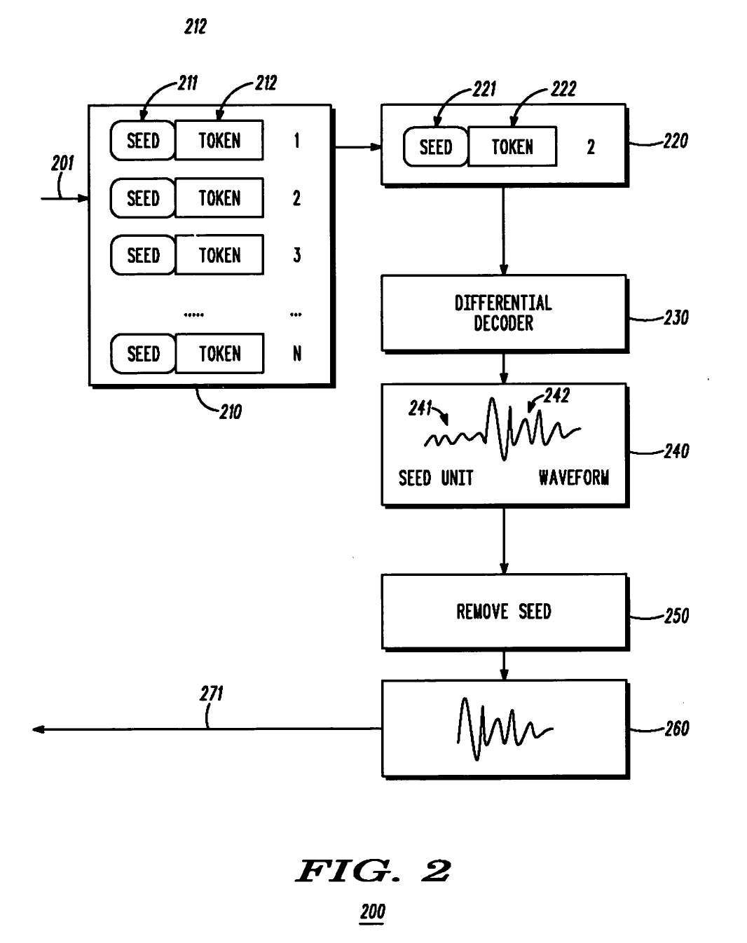

FIG. 2 shows a text to speech database processor 200 for use with a differential vocoder as the substitute for the generic text to speech database system of 125, in accordance with an embodiment of the invention. The input 201 to the text to speech database processor receives a request which may be simply in the form of an index value that corresponds to the desired compressed acoustic speech waveform in a database of compressed speech waveform units 210. A compressed acoustic speech waveform unit 220 is referred to as a preconditioned encoded speech token 220, and includes a seed token portion 221 and speech waveform unit portion 222 that have been differentially encoded together to form a preconditioned encoded speech token. The preconditioned encoded speech token database 210 generally contains 400 to 2000+ preconditioned encoded speech tokens that may be reconstructed into acoustic speech waveform units with-In the text to speech database processor 200 to provide the requested acoustic speech waveform unit to the text to speech process 100. A request, including an index value as determined by the dictionary 115, is received at input 201, and the preconditioned encoded speech token 220 associated with the index value is identified in the compressed database 210. The preconditioned encoded speech token data is passed from the database 210 to a differential vocoder 230 for decoding and providing a decompressed acoustic speech waveform. Since the decoding is performed by a differential vocoder, a seed token is needed to decode the preconditioned encoded speech token. The seed token used may be the same seed token used to encode the speech waveform unit into a preconditioned encoded speech token. Decoding the preconditioned encoded speech token results in a seeded speech waveform 240. The seeded speech waveform 240 contains a seed portion 241 and a speech waveform unit portion 242. The seed portion is the result of preconditioning with the seed token, and has no meaningful value in text to speech processing. The seed portion is removed 250 and the resulting waveform is the requested acoustic speech waveform unit 260, which is passed back to the text to speech process at an output 271.

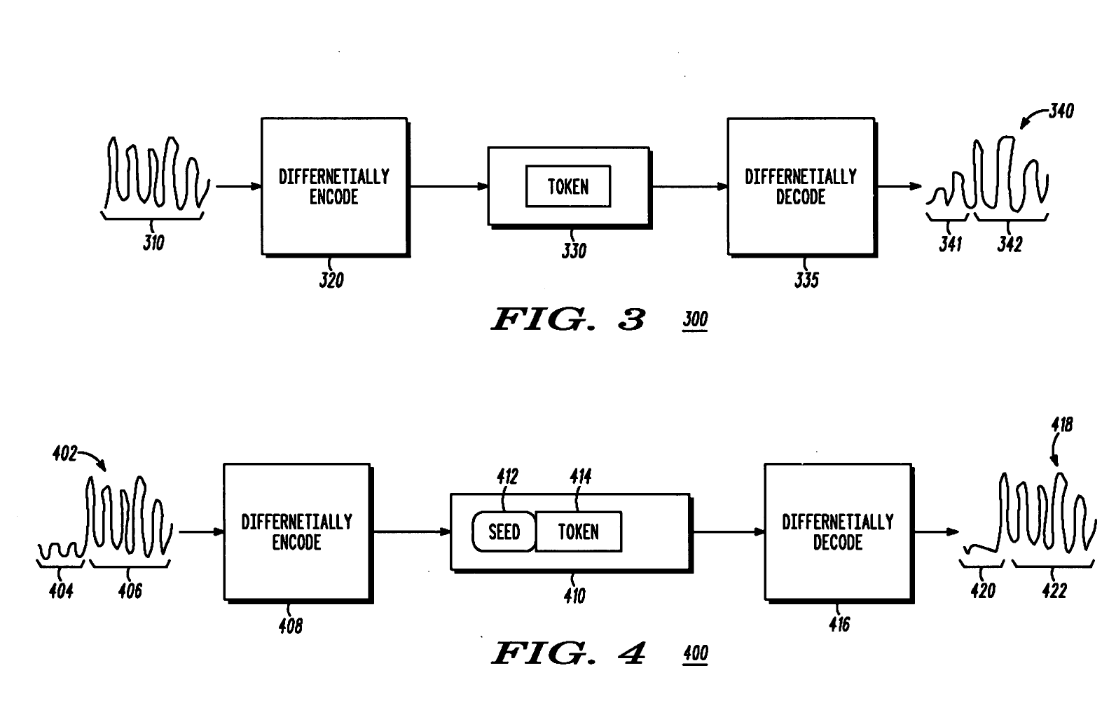

Referring now to FIG. 3, there is shown a process flow diagram 300 for encoding and decoding speech units, to illustrate an embodiment of the invention. The example shown in FIG. 3 illustrates a benefit of the invention and the application of differential vocoding. The process shown here, and subsequently in FIG. 4, shows how a text to speech database is populated with compressed diphones, and subsequently decompressed for presentation to a text to speech engine during text to speech operation. To populate the database, a series of diphone waveforms 310 must be represented in the database. The number of diphones required may vary depending on the performance desired by the text to speech engine and the resulting quality of the synthesized speech. Each diphone may be a recorded portion of actual speech stored in electronic form, and, ultimately, digitized for presentation to a differential vocoder 320. The differential vocoder 320 performs a differential vocoding process on the diphone data to produce an unconditioned token 330. The resulting data token 330 is considered to be unconditioned because no additional data was provided with the diphone data. The token is then stored in the database, and indexed for later reference and retrieval during text to speech operation. When the differentially encoded token is then needed for text to speech operation, it is fetched from the database, as indicated by the index value given in the request, as produced by the dictionary process. Upon retrieving the encoded unconditioned token 330, it is decompressed with a differential decoder 335 to produce a decoded speech waveform 340 which includes an onset portion 341 and waveform portion 342. However, because a differential decoding process is used to produce the speech waveform, the onset portion 341 is corrupted due to the lack of proper antecedent information used in the decoding process. Thus, the process shown here illustrates a problem when using differential vocoding methods for compression and subsequent expansion.

Referring now to FIG. 4, there is shown a process flow diagram 400 for encoding and decoding speech units, in accordance with an embodiment of the invention. The same processes used in FIG. 3 may be used here, with a difference being a seed waveform or speech data is used. The seeded speech waveform402 includes a speech waveform portion 406 that is derived from actual speech, and a seed portion 404 that is preappended to the speech data 406. The seed data allows the differential vocoder 408 to encode the seeded speech waveform in a predictable manner to allows reliable decoding subsequently, as will be explained. The seeded speech waveform is encoded to produce a seeded preconditioned encoded speech token 410 which includes a seed token portion 412 and encoded speech token portion 414. The seeded preconditioned encoded speech waveform 410 is then in proper form for storage in a text to speech database, properly indexed for subsequent retrieval as needed for later differential vocoder decoding. When the text to speech engine requires an acoustic speech waveform the database process fetches the indicated seeded preconditioned encoded speech token 410, and performs a differential vocoder decoding process 416 to decode the seeded preconditioned encoded speech token, which results in a seeded speech waveform 418. The preconditioning step is used to improve the onset dynamics of a synthesized encoded speech token.

In FIG. 3 a diphone 310 is extracted from a generic text to speech database and is presented to a differential vocoder 320 for encoding. The encoding produces a compressed form 330 of the waveform as a set of parameters that describe the information content of the speech waveform unit. The differential vocoder 320, 408 operates on a frame-by-frame basis and stores information about its current state in combination with its previous states. The differential vocoder imparts knowledge of its state onto the current encoded speech frame. In a differential vocoder, knowledge of previous frames is used in conjunction with current frame processing to generate the encoded parameter set, known as the encoded speech token 330. Synthesis of the current encoded speech token 330, by passing it through the differential vocoder 335, without the previous frame encoded speech token, can result in poor onset dynamics 341. The synthesized speech segment 340 contains an onset period 341 followed by the synthesized transient response 342. The transient response accurately represents synthesized speech because sufficient time has elapsed for the synthesis. However, the speech segment 340 synthesized from the isolated current encoded speech token 330 reveals poor onset dynamics 341. After the onset period the vocoder is able to acquire sufficient state information from the encoded frames to produce acceptable synthesized speech 342. The differential vocoder relies upon previous state information and when it is absent, reconstruction quality suffers, and can result is audio artifacts rather than speech.

To properly synthesize the onset portion, more than the current encoded speech token 330 is required. The differential vocoder requires the vocoder state history of at least one more encoded speech token. In FIG. 4, the acoustic speech waveform unit 406 is pre-appended with a seed waveform unit 404 to create a seeded speech waveform unit 402, in accordance with an embodiment of the invention. The purpose of the seed waveform unit is to give the differential vocoder sufficient data to reach steady state and allow it to properly synthesize the speech when the resulting seeded preconditioned encoded speech token 410 is later decoded. The vocoder may use the same seed waveform as a reference upon performing the differential decoding. Without a seed waveform, the differential vocoder is expected to produce differential state information where previous state information did not exist. Without proper state information the audio quality of the speech will be degraded in the onset region. For continuous speech, where the vocoder operates on contiguous frames of speech, the vocoder only requires previous state information at the start of the continuous speech. However, the text to speech acoustic waveform units will be synthesized numerous times non-contiguously over the course of text to speech synthesis which will lead to degraded quality due to poor onset dynamics at each diphone. The seeded speech waveform unit 402 is presented to a differential vocoder 408 for encoding. The encoding produce a seeded preconditioned speech token 410 with a seed portion token 412 and a preconditioned speech token 414. The seed portion is removed and stored separately from the preconditioned speech token. If the same seed token is presented for each diphone then the seed token 412 is also common to all the preconditioned speech tokens and it may be stored separately. Passing the seeded preconditioned speech token through the differential vocoder 416 results in a synthesized seeded acoustic speech waveform unit 418 which has a seed portion unit 420 and a speech portion unit 422. The seed portion unit is removed and the resulting speech portion unit is the acoustic speech waveform unit 422 to be passed back to the text to speech system.

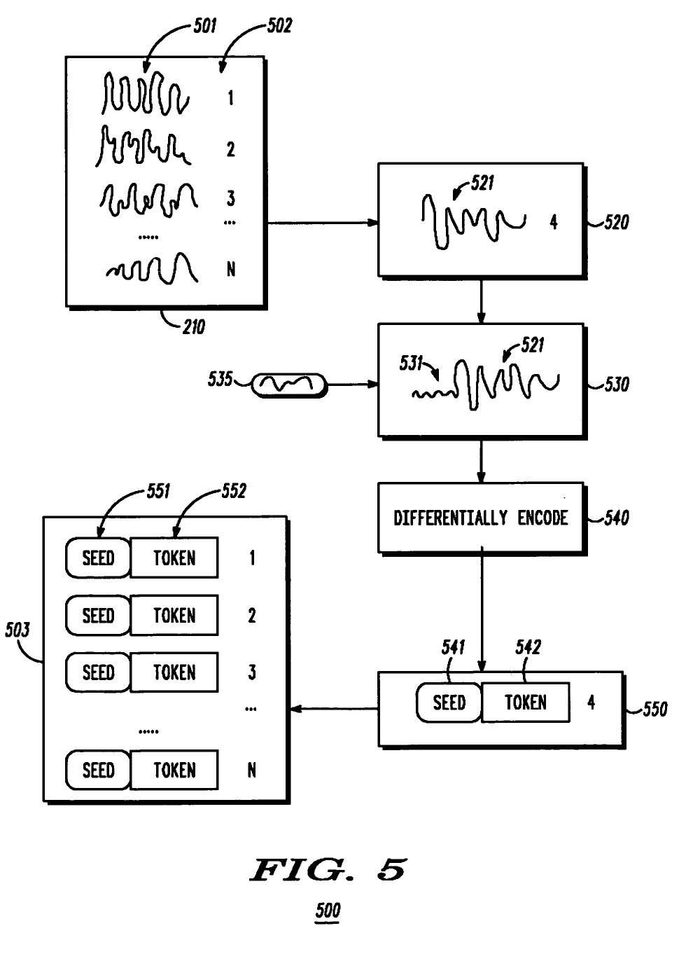

FIG. 5 illustrates a flow chart diagram 500 of a method for generating a database 503 of preconditioned encoded speech tokens. The method generates each preconditioned speech token from a given speech waveform in a database 210 having a plurality of speech waveform units 501, each one of the plurality of speech waveform units corresponding to a speech sound and having an assigned index value 502. Each speech waveform unit is retrieved 520 from the speech waveform database 210 for processing in accordance with an embodiment of the invention. The retrieved speech waveform unit 521 is pre-appended with a seed frame 535, such as a null reference frame, to provide a pre-appended speech waveform unit 530. The pre-appended speech waveform unit has a seed portion 531 and a waveform portion 521. The pre-appended speech waveform is then encoded with a differential vocoding process 540. The pre-appended speech waveform unit 530, upon encoding, provides a seeded preconditioned encoded speech token 550. The seeded preconditioned encoded speech token 550 consists of a seed token portion 541 and a preconditioned encoded speech token portion 542. Removing the seed token portion 541 from the seeded preconditioned encoded speech token 550, leaves a preconditioned encoded speech token 542. Upon storing in the database 503, the indexing of the preconditioned encoded speech token portion 542 corresponds with an index value 502 of the speech waveform token.

The process of pre-appending 530 may include retrieving the null reference frame from a stored memory location, and inserting the null reference frame at the beginning position of the speech waveform unit. The null reference frame has a length corresponding to a process delay of a differential encoding process of the differential vocoder. The differential vocoder operates on speech frames of prespecified length but may operate on variable length frames. For prespecified lengths the null frame must be at least the prespecified length in order for the differential vocoder to be properly configured. A differential vocoder operates on a differential process which typically requires at least one frame of preceding information. The null reference frame is a zero amplitude waveform that serves to prepare the differential encoding process for a zero amplitude frame reference. The zero amplitude waveform can also be created in place via a zero stuffing operation with the speech waveform unit. The retrieving, pre-appending, encoding, and indexing are repeated for each of the plurality of speech waveform tokens to create the entire database 503 from the speech waveform database 210. The seeded preconditioned encoded speech token 550 thus comprises a first encoded portion known as the seed token 541, which may be, for example, a null reference frame. Furthermore, there is a second encoded portion known as the encoded speech token 542. The first and the second encoded portions are differentially related through a differential coding process that imparts properties onto the second portion characteristic of the differential relationship occurring between the first and second encoded portion. The seed token 541 is preferably common to each of the plurality of encoded speech tokens 542. The seed token 541 may be stored separately, as a singular instantiation, from the preconditioned encoded speech tokens in the generated database 450 to further reduce the memory space needed to store the database.

Thus, the invention provides a speech synthesis method and a speech synthesis apparatus for memory constrained text to speech systems, in which differentially vocoded speech units are concatenated together by indexing into a compressed database which contains a collection of preconditioned encoded speech tokens. The invention provides a waveform preconditioning method for segmental speech synthesis by which acoustical mismatch is reduced, language-independent concatenation is achieved, and good speech synthesis using a differential vocoder may be performed. An embodiment of the invention provides a preconditioning speech synthesis database apparatus that performs the preconditioning speech synthesis method on a generic text to speech database to achieve a reduction in speech database size.

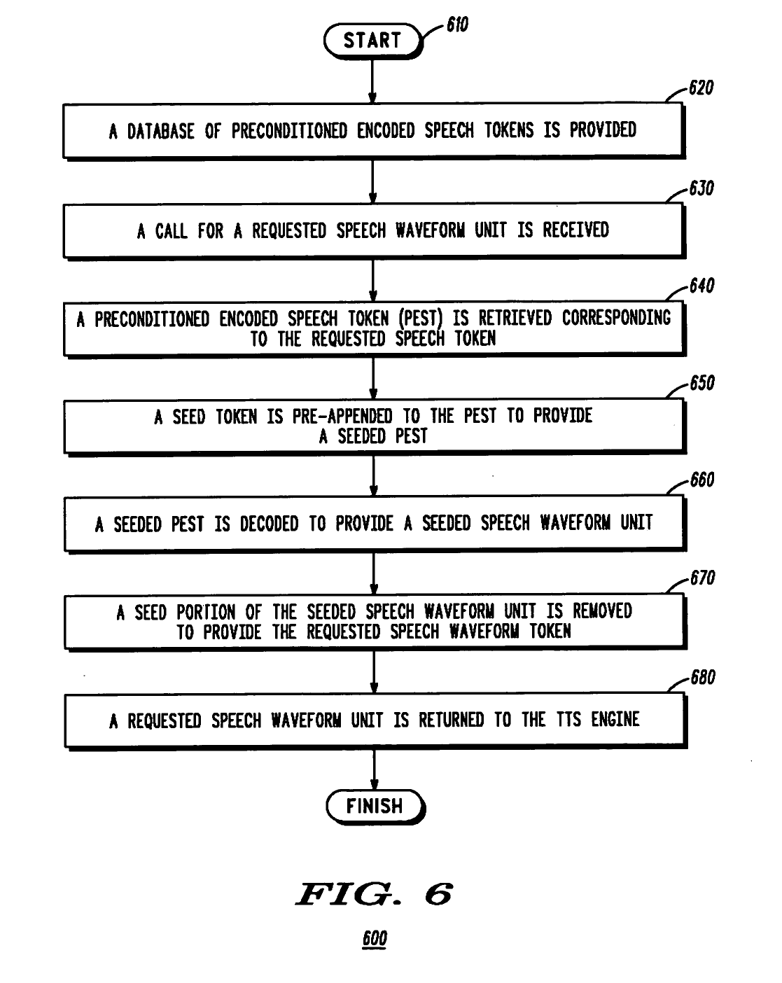

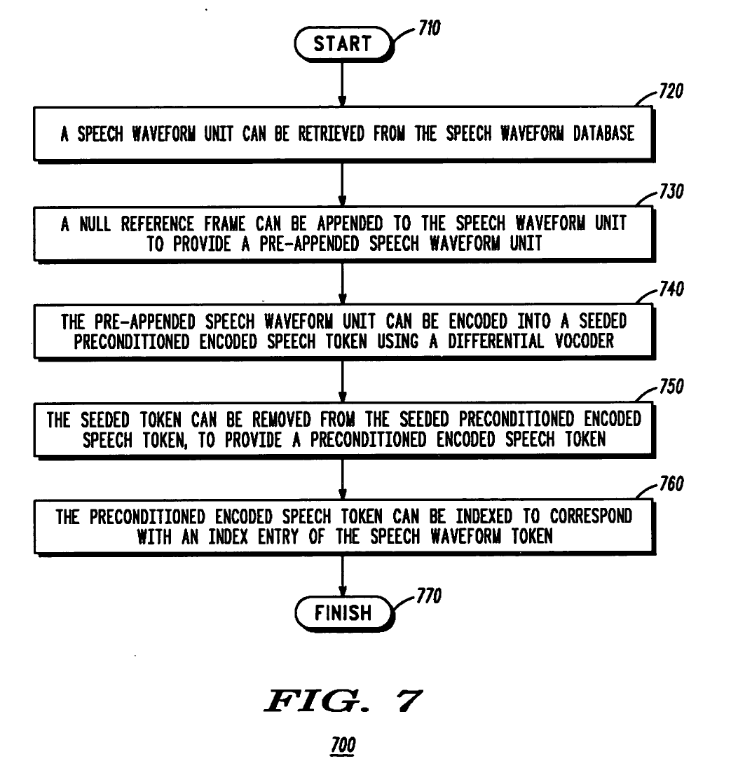

Referring now to FIG. 6, there is shown a flow chart diagram 600 of a method for facilitating Text-to-Speech synthesis, in accordance with an embodiment of the invention. Reference is made to FIGS. 1, 2, and 3, although it should be noted that the method is practiced in any suitable system or device. Moreover, the processes of the method are not limited to the particular order in which they are presented in FIGS. 1, 2, and 3. The inventive method may also have a greater number of steps or a fewer number of steps than those shown in FIG. 3. At the start 610 of the method the device is powered on and ready to commence text to speech synthesis in accordance with an embodiment of the invention. At step 620 a database of preconditioned encoded speech tokens is provided with each of the preconditioned encoded speech tokens in a differential encoding format. The database preferably comprises a sufficient number of speech token to create any needed speech. At step 630 a call from a text to speech engine for a requested speech waveform unit is generated where the requested speech waveform unit corresponding to a text segment is to be synthesized into speech. At step 640 a preconditioned encoded speech token corresponding to the requested speech waveform unit is retrieved from the database of preconditioned encoded speech tokens. At step 650 a seed token is pre-appended onto the preconditioned encoded speech token, to provide a seeded preconditioned encoded speech token. The preconditioning method is applied in order to prepare the differential vocoder for receiving small speech waveform units. The encoding of non-contiguous small speech waveforms units by a differential vocoder would otherwise produce onset corruptions. The onset corruptions are due to the differential encoding behavior of the differential vocoder. The preconditioning method sufficiently prepares the differential vocoder to receive the correct onset information and accordingly encode the correct onset information that will result in properly synthesized onset information during differential decoding. According to one aspect of the present invention, the preconditioned encoded speech token is created by the concatenation of a first seed portion and a second set of preconditioned encoded parameters. The first seed portion is retrieved from a memory location different from the second set of preconditioned encoded parameters, and is appended to the second set of preconditioned encoded parameters prior to differential decoding. At step 660 the seeded preconditioned encoded speech token is decoded with a differential vocoder to provide a seeded speech waveform unit having a seed portion followed by a speech waveform portion. At step 670 the seed portion is removed from the seeded speech waveform unit to provide the requested speech waveform unit without the onset data produced by the seed token through he differential decoding process. At step 680 the requested speech waveform unit is returned to the text to speech engine, and at the end 690 the database is ready to receive another request call for another speech waveform unit.

According to another embodiment of the invention, there is provided a method for requesting and retrieving preconditioned encoded speech token from a compressed text to speech database to be utilized within the operation of a text to speech system on a mobile device. The method consists of identifying the index for the speech waveform unit requested by the text to speech, retrieving the preconditioned encoded speech token from the compressed text to speech database corresponding to the index, providing the preconditioned encoded speech token to the differential vocoder to generate a synthesized preconditioned speech waveform unit, and returning the synthesized preconditioned speech waveform unit to the calling text to speech engine.

Referring to FIG. 7, there is shown a flow chart diagram 700 of a method of generating a database of preconditioned encoded speech tokens from a speech waveform database having a plurality of speech waveform units, each one of the plurality of speech waveform units corresponding to a speech sound, in accordance with an embodiment of the invention. At the start 710, a database of digitized speech waveforms suitable for use in speech synthesis is provided as the stock for generating the database. At step 720 one of the plurality of speech waveform units is retrieved from the speech waveform database. At step 730 a null reference frame is pre-appended to the speech waveform unit to provide a pre-appended speech waveform unit. The null waveform reference establishes a common base reference for which the differential vocoder will operate. In one arrangement the speech waveform units are preconditioned by preappending a null waveform reference to the speech waveform unit. In this method, a null waveform reference is preappended to the speech waveform unit, known as the preconditioned speech waveform unit, prior to differential vocoding. At step 740 the pre-appended speech waveform unit is encoded into a seeded preconditioned encoded speech token using a differential vocoder. The preconditioned encoded speech token can consist of a first and second set of parameters in a format familiar to the differential vocoder. The first set of the preconditioned encoded speech token parameters, known as the seed portion, can represent the null reference waveform. The second set of the preconditioned encoded speech token parameters represent the speech waveform portion. The preconditioned encoded speech tokens require less storage memory than their respective speech waveform tokens. At step 750 the seeded token from the seeded preconditioned encoded speech token is removed to provide a preconditioned encoded speech token. The preconditioned encoded speech token is separated into a first portion and a second portion. The first portion, known as the seed portion, which is characteristic of the null waveform reference is saved independently of the second portion. The seed portion, which is the same for all stored preconditioned speech waveform tokens, can be saved once and used over for every speech waveform request. The second portion, which is resultant of the speech waveform unit, is stored in the text to speech database without the seed token. In one arrangement, the method for requesting and retrieving preconditioned encoded speech token from a compressed text to speech database comprises cropping the preconditioned speech waveform unit to generate a speech waveform unit, and returning the cropped speech waveform unit that corresponds to the requested speech waveform unit. The method for cropping the synthesized preconditioned speech waveform includes isolating the section of the synthesized speech waveform unit that excludes the synthesized null waveform reference. At step 760 the preconditioned encoded speech token is indexed to correspond with an index entry of the speech waveform token.

According to one embodiment of the invention, there is provided a method of resetting the vocoder to a predetermined state at each occurrence of an encoded speech token. The predetermined state corresponds to the state of the vocoder at the time the null reference has been completely processed. At the time the null reference has been completely processed, the differential vocoder has captured the history of the null frame reference in its present vocoder state. Preservation and restoration of the vocoder state at the point corresponding to the null reference allows for the vocoder to resume processing at the null reference state.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for facilitating text to speech synthesis, comprising:
providing a database of preconditioned encoded speech tokens, each of the preconditioned encoded speech tokens in a differential encoding format;
receiving a call from a text to speech engine for a requested speech waveform unit, the requested speech waveform unit corresponding to a text segment to be synthesized into speech;
retrieving from the database of preconditioned encoded speech tokens a preconditioned encoded speech token corresponding to the requested speech waveform unit;
pre-appending a seed token onto the preconditioned encoded speech token, to provide a seeded preconditioned encoded speech token;
decoding the seeded preconditioned encoded speech token with a differential vocoder to provide a seeded speech waveform unit having a seed portion followed by a speech waveform portion;
removing the seed portion from the seeded speech waveform unit to provide the requested speech waveform unit; and
returning the requested speech waveform unit to the text to speech engine.

2. The method of claim 1, wherein the requested speech waveform unit is used in a concatenative text to speech process.

3. The method of claim 1, wherein pre-appending the seed token onto the preconditioned encoded speech token comprises:
retrieving the seed token from a stored memory location; and
inserting the seed token at a beginning position of the preconditioned encoded speech token.

4. The method of claim 1, wherein the seed token is an encoded form of a seed waveform unit with a seed waveform unit length corresponding to a process delay associated with the differential decoding process of the seed waveform unit.

5. The method of claim 1, wherein the seed token is an encoded form of a seed waveform unit with said seed waveform unit representing a zero amplitude waveform.

6. The method of claim 1, wherein the seeded preconditioned encoded speech token comprises:
a first encoded portion; and
a second encoded portion;
wherein the first and the second encoded portions are differentially related.

7. The method of claim 5, wherein a common seed token is pre-appended to each of the plurality of preconditioned encoded speech tokens.

8. The method of claim 5, wherein the seed token is stored separately from the preconditioned encoded speech token.

9. The method of claim 1, wherein removing the seed portion from the seeded speech waveform unit comprises:
identifying the seed portion from the seeded speech waveform unit, the seed portion having a first length corresponding to a length of the seed waveform unit;
removing a first portion of the seeded speech waveform unit from a region beginning at a first waveform sample to a waveform sample corresponding to the length of the seed waveform unit.

10. The method of claim 1, wherein the returning the requested speech waveform unit comprises:
identifying the seed portion from the seeded speech waveform unit, the seed portion having a first sample length corresponding to a length of the seed waveform unit and a second sample length corresponding to the sample length of the speech waveform unit; and
returning a second portion of the seeded speech waveform unit from a region beginning at a sample corresponding to the seed waveform length to a last sample of the seeded speech waveform unit.

11. A method of generating a database of preconditioned encoded speech tokens from a speech waveform database having a plurality of speech waveform units, each one of the plurality of speech waveform units corresponding to a speech sound, the method comprising:
retrieving from the speech waveform database one of the plurality of speech waveform units;
pre-appending a null reference frame to the speech waveform unit to provide a pre-appended speech waveform unit;
encoding the pre-appended speech waveform unit into a seeded preconditioned encoded speech token using a differential vocoder;
removing the seeded token from the seeded preconditioned encoded speech token, to provide a preconditioned encoded speech token; and
indexing the preconditioned encoded speech token to correspond with an index entry of the speech waveform token.

12. A method of generating a database of preconditioned encoded speech tokens as defined in claim 11, wherein retrieving, pre-appending, encoding, and indexing are repeated for at least one more of the plurality of speech waveform tokens.

13. A method of generating a database of preconditioned encoded speech tokens as defined in claim 11, wherein retrieving, pre-appending, encoding, and indexing are repeated for each of the plurality of speech waveform tokens.

14. A method of generating a database of preconditioned encoded speech tokens as defined in claim 11, wherein pre-appending a null reference frame comprises
retrieving the null reference frame from a stored memory location; and,
inserting the null reference frame at the beginning position of the speech waveform token;

15. A method of generating a database of preconditioned encoded speech tokens as defined in claim 11, wherein the null reference frame is a zero amplitude waveform.

16. A method of generating a database of preconditioned encoded speech tokens as defined in claim 11, wherein the null reference frame has a length corresponding to a process delay of a differential encoding process of the differential vocoder.

17. A method of generating a database of preconditioned encoded speech tokens as defined in claim 11, wherein the seeded preconditioned encoded speech token comprises:
a first encoded portion;
a second encoded portion; and
wherein the first and the second encoded portions are differentially related.

18. A method of generating a database of preconditioned encoded speech tokens as defined in claim 17, wherein the seed token is a common seed token pre-appended to each of the plurality of preconditioned encoded speech tokens.

19. A method of generating a database of preconditioned encoded speech tokens as defined in claim 17, wherein the seed token is stored separately from the preconditioned encoded speech token.
